(19) United States
(12) Patent Application Publication
(10) Pub. No.: US 2017/0343408 A1
(43) Pub. Date: Nov. 30, 2017

(54) LIQUID LEVEL DETECTION DEVICE

(71) Applicant: DENSO CORPORATION, Kariya-city, Aichi-pref. (JP)

(72) Inventor: Hiroshi HASHIMOTO, Kariya-city (JP)

(73) Assignee: DENSO CORPORATION, Kariya-city, Aichi-pref. (JP)

(21) Appl. No.: 15/527,214

(22) PCT Filed: Nov. 23, 2015
(86) PCT No.: PCT/JP2015/005815

§ 371 Date: May 16, 2017

(30) Foreign Application Priority Data
Dec. 12, 2014 (JP) 2014-252260

(51) Int. Cl. G01F 23/36; G01F 23/38

(52) U.S. Cl. CPC G01F 23/36; G01F 23/38

(57) ABSTRACT

A liquid level detection device is provided with a fixed body and a rotating body, and includes a float floating and an arm. The arm has an insertion section to be inserted into the rotating body and an extending section extending linearly and bent with respect to the insertion section. The rotating body has an insertion hole in which the insertion section of the arm is inserted in an insertion direction and a holding section having a receiving opening which receives the extending section and holding the extending section received by the receiving opening. The fixed body has a guide section covering the extending portion in a part of a region between a portion held by the holding section and a portion connected to the float within a rotatable angular range of the arm. The guide section is provided with a passing section used to dispose the part of the extending section inside the guide section.

### CROSS REFERENCE TO RELATED APPLICATION

This application is based on Japanese Patent Application No. 2014-252260 filed on Dec. 12, 2014, the disclosure of which is incorporated herein by reference.

### TECHNICAL FIELD

The present disclosure relates to a liquid level detection device detecting a liquid level of a liquid stored in a container.

### BACKGROUND ART

A liquid level detection device in the related art which detects a liquid level of a liquid contained in a container is known. In particular, a liquid level detection device disclosed in Patent Literature 1 includes a fixed body fixed to a container, a rotating body rotating with respect to the fixed body, a float floating in a liquid, and an arm connecting the float and the rotating body and allowing the rotating body to rotate with up and down motions of the float. The rotating body has an insertion hole in which an insertion section of the arm is inserted in an insertion direction and a holding section having a receiving opening which receives an extending section and holding the received extending section.

### PRIOR ART LITERATURES

### Patent Literature

Patent Literature 1: JP9-152369A

### SUMMARY OF INVENTION

The liquid level detection device of Patent Literature 1, however, is not provided with a guide section. Hence, in cases where the extending section comes off the holding section due to various factors, such as an external force, the insertion section immediately comes off the insertion hole, in which case the arm is separated from the rotating body and a function furnished to the device may possibly be lost.

An object of the present disclosure is to provide a liquid level detection device having a high arm holding strength.

According to an aspect of the present disclosure, the liquid level detection device is provided with a fixed body fixed to a container and a rotating body rotating with respect to the fixed body, and detects a liquid level of a liquid contained in the container by means of a relative angle of the rotating body with respect to the fixed body. The liquid level detection device includes a float floating in the liquid, and an arm connecting the float and the rotating body and allowing the rotating body to rotate with up and down motions of the float. The arm has an insertion section to be inserted into the rotating body and an extending section extending linearly and bent with respect to the insertion section. The rotating body has an insertion hole in which the insertion section of the arm is inserted in an insertion direction and a holding section having a receiving opening which receives the extending section and holding the extending section received by the receiving opening. The fixed body has a guide section covering the extending portion in a part of a region between a portion held by the holding section and a portion connected to the float within a rotatable angular range of the arm. The guide section is provided with a passing section used to dispose the part of the extending section inside the guide section.

According to the liquid level detection device, the guide section covers the extending section in the part of the region between a portion held by the holding section and a portion connected to the float within the rotatable angular range of the arm. In cases where the extending section comes off the holding section due to various factors, such as an external force, a worst event that the insertion section comes off the insertion hole can be restricted because the part of the extending section disposed inside the guide section through the passing section hits the guide section. Consequently, the liquid level detection device in which the arm is held by a high holding strength be provided.

### BRIEF DESCRIPTION OF DRAWINGS

The above and other objects, features and advantages of the present disclosure will become more apparent from the following detailed description made with reference to the accompanying drawings. In the drawings:

FIG. 1 is a front view showing a liquid level detection device of one embodiment set in a fuel tank;

FIG. 2 is an enlarged front view showing a part of FIG. 1;

FIG. 3 is a view partially showing a cross section taken along the line III-III of FIG. 2 as a sectional view particularly showing a shape of a holding claw;

FIG. 4 is a side view of a housing when viewed in a direction IV of FIG. 2;

FIG. 5 is a side view corresponding to FIG. 4 and used to describe a step of passing an extending section through a passing section in a fabrication process;

FIG. 6 is a front view showing a relation among a rotatable angular range, a mounting angle, and a passing section angle of one embodiment; and

FIG. 7 is a view of a first modification corresponding to FIG. 6.

### DESCRIPTION OF EMBODIMENTS

Hereinafter, one embodiment of the present disclosure will be described according to the drawings.

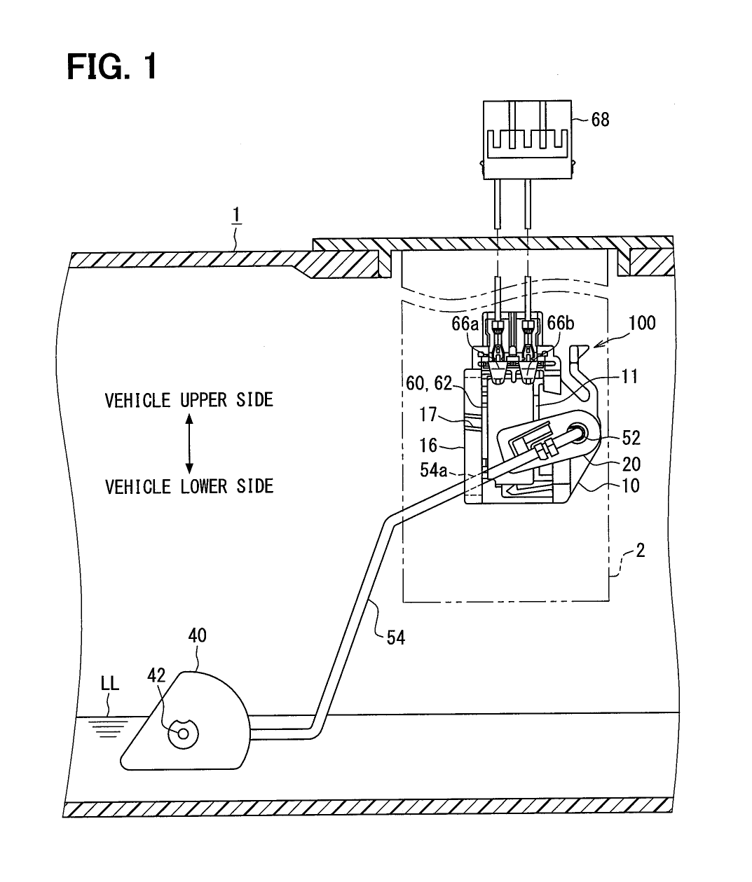

As is shown in FIG. 1, a liquid level detection device 100 according to one embodiment of the present disclosure is set in a fuel tank 1 in a vehicle as a container in which fuel as a liquid is contained and held by a fuel pump module 2 or the like. The liquid level detection device 100 includes a float 40, an arm 50, an insulator 20 as a rotating body, a housing 10 as a fixed body, a circuit board 62, and a sliding plate 64. The liquid level detection device 100 detects a liquid level LL of the fuel contained in the fuel tank 1 by means of a relative angle of the insulator 20 with respect to the housing 10 detected by a variable resistor 60 chiefly formed of the circuit board 62 and the sliding plate 64 and functioning as a detection mechanism.

The float 40 is made of a material having a lower specific gravity than fuel, for example, foamed ebonite, and as is shown in FIG. 1, floats on a liquid surface of the fuel. That is to say, the float 40 moves up and down with a change of the liquid level LL. The float 40 is held by the insulator 20 via the arm 50.

The arm 50 is formed of a core shaped like a round bar and made of metal, such as stainless steel, and connects the float 40 and the insulator 20. A first end of the arm 50 is inserted into a through-hole 42 provided to the float 40. A second end of the arm 50 is held by the insulator 20 using a holding mechanism 22 of the insulator 20. More specifically, the arm 50 has an insertion section 52 to be inserted into the insulator 20 on the side of the end held by the holding mechanism 22 and an extending section 54 extending linearly and bent with respect to the insertion section 52.

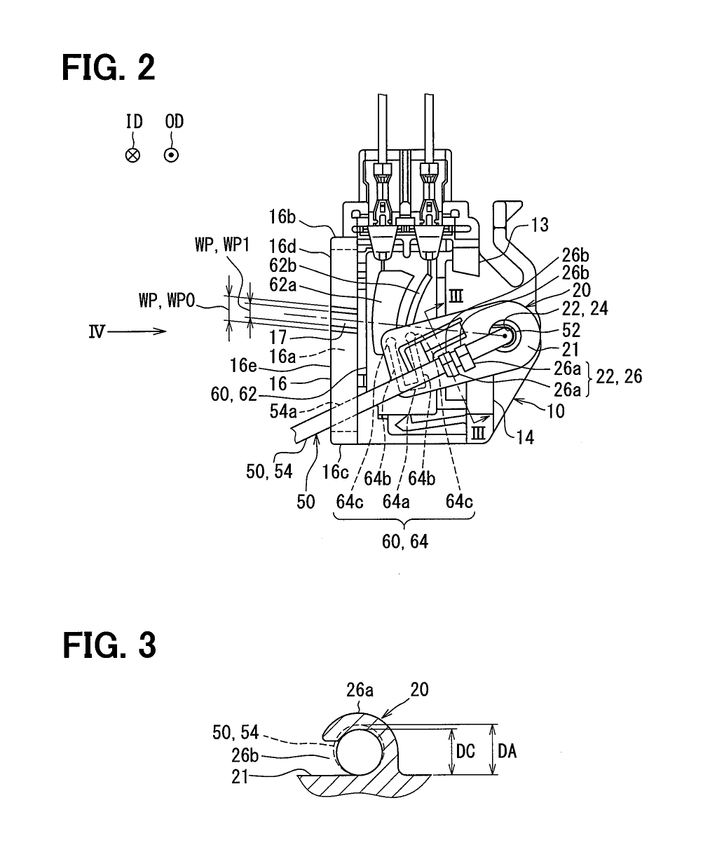

As are shown in FIGS. 1 and 2, the insulator 20 is made of synthetic resin, for example, polyacetal (POM) resin. The sliding plate 64 is attached to the insulator 20 and also the arm 50 is mounted to the insulator 20. The insulator 20 has an insertion hole 24, a holding section 26, and so on as members instituting the holding mechanism 22.

The insertion hole 24 is a cylindrical hole in which the insertion section 52 of the arm 50 is inserted in an insertion direction ID. In the present embodiment, in particular, the insertion hole 24 is provided so as to penetrate through the insulator 20 and lies next to a boss section 12 of the housing 10.

The holding section 26 includes two holding claws 26a provided side by side along a radial direction of the insertion hole 24. As is shown FIG. 3 in detail, each holding claw 26a protrudes from an outer surface 21 facing an opposite direction OD to the insertion direction ID and forms a claw shape bent in an arc. Each holding claw 26a opposes the outer surface 21 at a tip end and therefore has a receiving opening 26b which receives the extending section 54 of the arm 50 in a circumferential direction of the insertion hole 24.

A minor diameter DC of each of the holding claws 26a is slightly smaller than a diameter DA of the extending section 54. Accordingly, each of the holding claws 26a of the holding section 26 in an elastically deformed state hold the extending section 54 received by the receiving openings 26b by sticking to the extending section 54.

A direction in which the receiving openings 26b of the present embodiment receive the extending section 54 is the circumferential direction of the insertion hole 24 pointing from a vehicle upper side to a vehicle lower side in a state where the liquid level detection device 100 is set in the fuel tank 1 as shown in FIG. 1. That is to say, the holding section 26 receives the extending section 54 from the vehicle upper side and holds the extending section 54 received by the receiving openings 26b while lifting up the extending section 54 from the vehicle lower side. The term, “the vehicle lower side”, referred to herein is used to specify a direction in which a gravitational force is induced when the vehicle is present on a level ground. The term, “the vehicle upper side”, referred to herein is used to specify a direction opposite to the direction specified by the vehicle lower side.

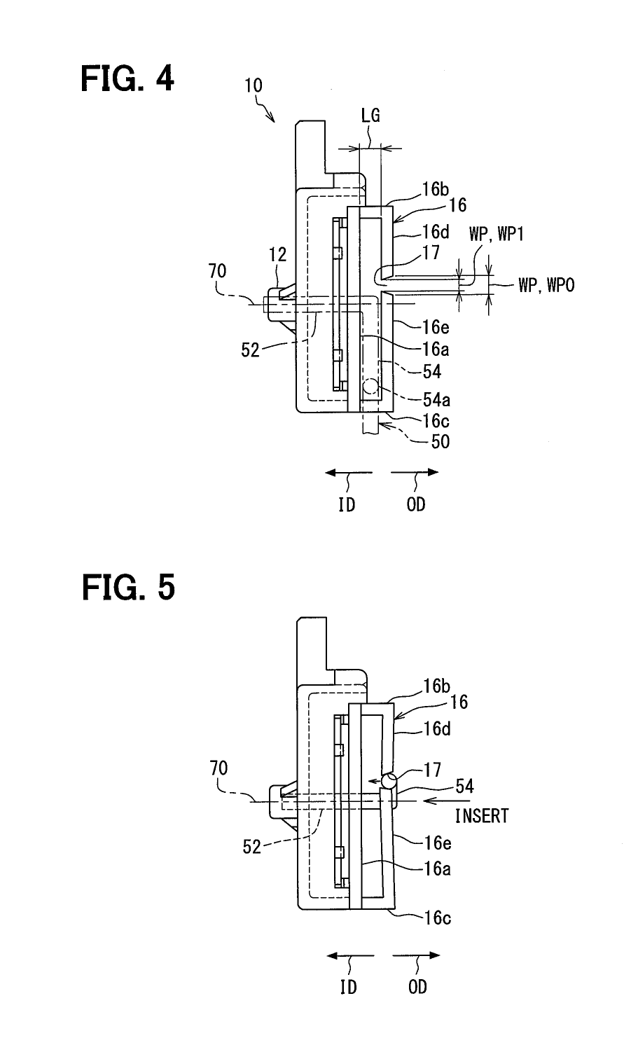

The insertion section 52 of the arm 50 is passed through the insertion hole 24 of the insulator 20 holding the arm 50 in the manner as above. Further, by inserting a tip end of the insertion section 52 into the boss section 12 shown in FIG. 4, the insertion section 52 functions as a rotation shaft 70. Consequently, the insulator 20 is supported on the housing 10 in a rotatable manner.

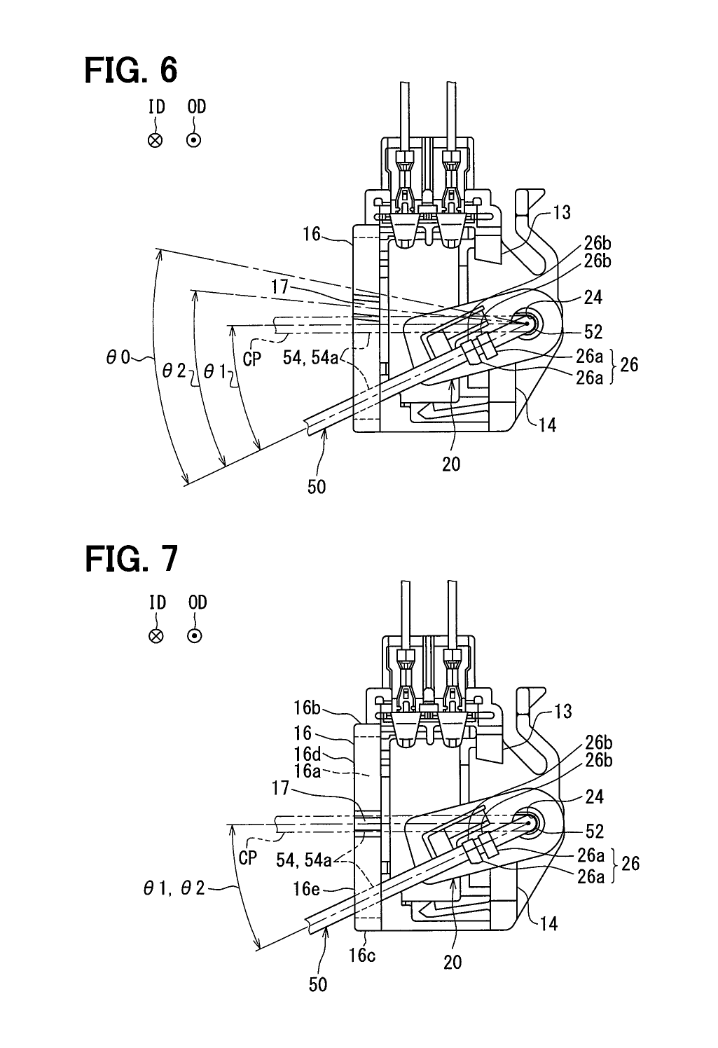

In the liquid level detection device 100 configured as above, the arm 50 allows the insulator 20 to rotate with up and down motions of the float 40. That is to say, the insulator 20 and the arm 50 held by the insulator 20 rotate with respect to the housing 10 within a predetermined rotatable angular range θ0 (for example, within a range of 40°, see also FIG. 6).

The housing 10 is made of synthetic resin, for example, POM resin, and as are shown in FIGS. 1, 2, and 4, fixed to the fuel tank 1 via the fuel pump module 2. The circuit board 62 and a plus terminal 66a and a minus terminal 66b connected to the circuit board 62 are attached to the housing 10. The housing 10 is shaped like a container having a bottom portion and a side wall and forms a board storing section 11 in which to store the circuit board 62. The housing 10 is also provided with the boss section 12 through which to pass the tip end of the insertion section 52 as described above.

The housing 10 configured as above has an F-point stopper 13, an E-point stopper 14, and a guide section 16. The two stoppers 13 and 14 are provided as protrusions protruding in the opposite direction OD to the insertion direction ID and limit the rotatable angular range θ0 of the insulator 20 by being in contact with side surfaces of the insulator 20. The F-point stopper 13 is a stopper limiting the rotatable angular range θ0 in an upward direction corresponding to a rise of the liquid level LL in a rotational direction of the insulator 20. The E-point stopper 14 is a stopper limiting the rotatable angular range θ0 in a downward direction corresponding to a fall of the liquid level LL in the rotational direction of the insulator 20. In the present embodiment, in particular, the E-point stopper 14 is provided more on the vehicle lower side than the F-point stopper 13. Hence, the receiving openings 26b of the holding section 26 receive the extending section 54 in a direction pointing from the F-point stopper 13 to the E-point stopper 14.

The guide section 16 shaped like a rectangular tube is provided integrally with the housing 10 at a point at which the guide section 16 does not cross the insulator 20. The guide section 16 chiefly includes a main body section 16a with an inner side facing the opposite direction OD to the insertion direction ID, two end sections 16b and 16c protruding from both ends of the main body section 16a in the opposite direction OD, and two rib sections 16d and 16e protruding, respectively, from the two end sections 16b and 16c along the main body section 16a in such a manner that tip ends oppose each other and inner sides face the insertion direction ID.

The extending section 54 of the arm 50 is inserted inside the guide section 16 configured as above. Hence, the guide section 16 covers the extending section 54 in a part 54a of a region between a portion held by the holding section 26 and a portion connected to the float 40 within the rotatable angular range θ0 of the arm 50. More specifically, a space between the two end sections 16b and 16c is set wider than the rotatable angular range θ0 of the extending section 54 that rotates. That is to say, each of the end sections 16b and 16c has a clearance with the extending section 54 located at a limited end of the rotatable angular range θ0.

Also, as is shown in FIG. 4, it is most suitable for the guide section 16 to set an interval LG between the main body section 16a and the rib sections 16d and 16e in the insertion direction ID to be larger than the diameter DA of the extending section 54 within a range of two times the diameter DA. When the interval LG is too small, the guide section 16 may possibly interfere with a rotation of the extending section 54 within the rotatable angular range 00. Conversely, when the interval LG is too large, the guide section 16 fails to fully exert the function of guiding the extending section 54. Moreover, a physical size of the liquid level detection device 100 is undesirably increased.

As are shown in FIG. 2 and FIG. 4, the guide section 16 is provided with a passing section 17 at a location where the two rib sections 16d and 16e oppose each other. The passing section 17 is an opening used to dispose the part 54a of the extending section 54 inside the guide section 16 by allowing the part 54a to pass through the guide section 16 from outside to inside. The passing section 17 is provided so as to incline with respect to a protruding direction of the rib sections 16d and 16e along the radial direction of the insertion hole 24. By tapering tip ends of the two rib sections 16d and 16e, a width WP of the passing section 17 is made different on an outer side and an inner side of the guide section 16. More specifically, the width WP is larger than the diameter DA of the extending section 54 on an outermost side (let the width WP on the outermost side be WP0) and the width WP gradually becomes narrower toward the inner side of the guide section 16 and becomes smaller than the diameter DA on an innermost side (let the width WP on the innermost side be WP1). Each of the rib sections 16d and 16e is allowed to undergo elastic deformation in the insertion direction ID (see also FIG. 5). In FIG. 4, the arm 50 at a position corresponding to a position in FIG. 2 is indicated by an alternate long and two short dashes line.

The circuit board 62 is made of ceramics or the like, and as are shown in FIGS. 1 and 2, held by the housing 10 while being stored in the board storing section 11. A set of resistive element patterns 62a and 62b as a detection circuit is provided to the circuit board 62 on a surface on a side of the insulator 20. Each of the resistive element patterns 62a and 62b is shaped like an arc about the rotation shaft 70. The resistive element pattern 62a on an outer peripheral side is formed by aligning multiple resistive elements having a predetermined electrical resistance value. The resistive element pattern 62a is an electrode pattern forming a plus pole and electrically connected to the plus terminal 66a. The resistive element pattern 62b on an inner peripheral side is an electrode pattern forming a minus pole and electrically connected to the minus terminal 66b. Accordingly, ground potential is applied to the resistive element pattern 62b via a connector 68.

As is shown in FIG. 2, the sliding plate 64 is a plate-like conductive member made of metal, and attached to the insulator 20 on a side opposing the circuit board 62. The sliding plate 64 is shaped like a capital U as a whole and has a coupling section 64a, a pair of flexible sections 64b extending from both ends of the coupling section 64a, and a pair of sliding contact points 64c provided to tip ends of the flexible sections 64b. By attaching the coupling section 64a to the insulator 20, the sliding plate 64 is allowed to rotate with the insulator 20 as one unit. The flexible sections 64b are capable of being bent in a plate thickness direction of the circuit board 62. The sliding contact points 64c are pressed against the resistive element patterns 62a and 62b due to elasticity of the flexible sections 64b, respectively.

The circuit board 62 and the sliding plate 64 together form the variable resistor 60 functioning as the detection mechanism. An electrical resistance value of the detection circuit varies with a relative angle of the insulator 20 with respect to the housing 10. More specifically, when the insulator 20 rotates, the sliding plate 64 undergoes relative displacement with respect to the circuit board 62 while the sliding contact points 64c are in contact with the resistive element patterns 62a and 62b, respectively. The electrical resistance value of the detection circuit decreases to a minimum when the insulator 20 becomes in contact with the F-point stopper 13 and therefore the sliding contact points 64c are in closest proximity to the terminals 66a and 66b, respectively. The electrical resistance value of the detection circuit increases gradually while the sliding contact points 64c in closest proximity to the terminals 66a and 66b move away from the terminals 66a and 66b in association with a rotation of the insulator 20. Eventually, the electrical resistance value of the detection circuit increases to a maximum when the insulator 20 becomes in contact with the E-point stopper 14 and therefore the sliding contact points 64c are at remotest positions from the terminals 66a and 66b, respectively. According to the principle as above, the variable resistor 60 is capable of detecting a relative angle. An outside device (for example, a combination meter) connected to the variable resistor 60 becomes capable of obtaining a potential difference between the terminals 66a and 66b corresponding to the electrical resistance value of the detection circuit as detection information of the liquid level LL.

A fabrication process to mount the arm 50 to the insulator 20 will now be described briefly.

Firstly, the arm 50 is set. More specifically, the insertion section 52 of the arm 50 is aligned with the insertion hole 24 while the insulator 20 is in a posture in which the insulator 20 is in contact with the E-point stopper 14 of the housing 10. Herein, the extending section 54 is disposed so as to overlap the passing section 17 in the insertion direction ID at a position displaced from the holding section 26 in the circumferential direction of the insertion hole 24. The part 54a of the extending section 54 extending linearly from a point bent with respect to the insertion section 52 is thus disposed in a same direction as the passing section 17 which is provided along the radial direction of the insertion hole 24.

Subsequently, the insertion section 52 of the arm 50 is inserted into the insertion hole 24 of the insulator 20 in the insertion direction ID and the extending section 54 is passed through the passing section 17. In the present embodiment in which the innermost width WP1 of the passing section 17 is smaller than the diameter DA of the extending section 54, as is shown in FIG. 5, each of the rib sections 16d and 16e is forced to undergo elastic deformation in the insertion direction ID by pressing the extending section 54 against the tapered tip end of each of the rib sections 16d and 16e. Consequently, a width wide enough for the extending section 54 to pass through is formed between the rib sections 16d and 16e by the passing section 17. Once the part 54a of the extending section 54 is passed through the passing section 17, the part 54a is disposed inside the guide section 16. FIG. 5 shows the extending section 54 in cross section by omitting a portion on a side of the float 40 from the guide section 16.

Subsequently, the extending section 54 is rotated toward the receiving openings 26b about the insertion hole 24 as a shaft. While the extending section 54 is rotated, the extending section 54 reaches a position at which an edge of the extending section 54 becomes in contact with the holding section 26 of the insulator 20 which is in contact with the E-point stopper 14. The position of the extending section 54 as above is defined to be a contact position CP (see an alternate long and two short dashes line of FIG. 6). That is to say, in the present embodiment, the passing section 17 is provided at a position opposite to the holding section 26 with the contact position CP in between. Hence, the extending section 54 reaches the contact position CP within a rotation stroke of the extending section 54.

Subsequently, the extending section 54 is inserted into the holding section 26 through the receiving openings 26b. More specifically, when the extending section 54 is pushed into the receiving openings 26b by rotating the extending section 54 further, the holding claws 26a as the holding section 26 are forced to undergo elastic deformation. Consequently, the extending section 54 is received by the holding section 26 as is shown in FIG. 2. In the manner as above, the arm 50 is mounted to the insulator 20 while the insulator 20 is in a stable posture in which the insulator 20 is in contact with the E-point stopper 14 of the housing 10.

As is shown in FIG. 6, let a rotational angle from the contact position CP to the position of the extending section 54 received by the holding section 26 when the insulator 20 is in a posture in which the insulator 20 is in contact with the E-point stopper 14 be a mount angle θ1. Also, let an angle formed between the passing section 17 and the extending section 54 received by the holding section 26 about the insertion hole 24 when the insulator 20 is in a posture in which the insulator 20 is in contact with the E-point stopper 14 be a passing section angle θ2. Then, the passing section 17 is provided at a position at which the passing section angle θ2 is equal to or larger than the mount angle θ1. Owing to the configuration as above, the arm 50 can be mounted in the procedure described above.

The following will describe an operational-effect of the present embodiment described above.

In the present embodiment, the guide section 16 covers the extending section 54 in the part 54a of the region between a portion held by the holding section 26 and a portion connected to the float 40 within the rotatable angular range θ0 of the arm 50. In cases where the extending section 54 comes off the holding section 26 due to various factors, such as an external force, a worst event that the insertion section 52 comes off the insertion hole 24 can be restricted because the part 54a of the extending section 54 disposed inside the guide section 16 through the passing section 17 hits the guide section 16. Consequently, the liquid level detection device 100 in which the arm 50 is held by a high holding strength be provided.

In the present embodiment, the passing section 17 becomes narrower toward the inner side of the guide section 16. Owing to the configuration as above, when the extending section 54 is passed through the passing section 17 in the insertion direction ID, the extending section 54 can be passed through the passing section 17 while forcing the guide section 16 to gradually undergo elastic deformation in the insertion direction ID. In addition, the passing section 17 on the side closest to the insertion direction ID is smaller than the diameter DA of the extending section 54 in a state where the extending section 54 is held by the holding section 26. Hence, the extending section 54 can be restricted from passing through the passing section 17 to the outside of the guide section 16 or from being hooked to the passing section 17.

In the present embodiment, the part 54a of the extending section 54 extends linearly from a point bent with respect to the insertion section 52 and the passing section 17 is provided along the radial direction of the insertion hole 24. Owing to the configuration as above, the extending section 54 extending along the radial direction of the insertion hole 24 can be readily passed through the passing section 17 when the insertion section 52 of the arm 50 is inserted into the insertion hole 24. Hence, the arm 50 can be mounted smoothly. Consequently, the arm 50 can not only be easy to mount but also held by a high holing strength.

In the present embodiment, the extending section 54 also moves in the insertion direction ID when the insertion section 52 of the arm 50 is inserted into the insertion hole 24 in the insertion direction ID to mount the arm 50. Herein, the extending section 54 can be readily disposed inside the guide section 16 by passing the extending section 54 through the passing section 17 provided to the guide section 16. By passing the extending section 54 through the passing section 17 provided at a position opposite to the holding section 26 with the contact position CP in between while the insulator 20 as a rotting body is in contact with the E-point stopper 14, crossing of the extending section 54 and the holding section 26 can be avoided. By rotating the extending section 54 along the circumferential direction of the insertion hole 24, the extending section 54 is held by the holding section 26 through the receiving openings 26b. In the manner as above, the arm 50 can not only be easy to mount but also held by a high holding strength.

In the present embodiment, the guide section 16 forms clearances with the extending section 54 held by the holding section 26 at the end sections 16b and 16c. Owing to the configuration as above, an event that the guide section 16 is in contact with the extending section 54 and the extending section 54 comes off the holding section 26 can be avoided. Hence, an arm holding strength can be increased.

In the present embodiment, the guide section 16 is provided integrally with the housing 10 as the fixed body. Owing to the configuration as above, the arm 50 can not only be easy to mount but also held by a high holding strength using a smaller number of components.

### Other Embodiment

The present disclosure is not limited to the embodiments mentioned above, and can be applied to various embodiments which are also within the spirit and scope of the present disclosure.

More specifically, in a first modification, as shown in FIG. 7, the passing section 17 may be provided at a position at which the passing section 17 overlaps the contact position CP in an insertion direction ID.

In a second modification, a width WP of the passing section 17 may not become narrower toward an inner side of the guide section 16. Alternatively, the width WP of the passing section 17 from an outer side to the inner side may remain equal to or larger than a diameter DA of the extending section 54.

In a third modification, the passing section 17 may not be provided along a radial direction of the insertion hole 24. For example, the passing section 17 may be provided so as to be orthogonal to a protruding direction of rib sections 16d and 16e.

In a fourth modification, receiving openings 26b of the holding section 26 may receive the extending section 54 in a direction pointing from the E-point stopper 14 to the F-point stopper 13. According to a fabrication process in such a case, the arm 50 can be mounted to the insulator 20 while the insulator 20 is in a posture in which the insulator 20 is in contact with the F-point stopper 13 of the housing 10.

In a fifth modification, receiving openings 26b of the holding section 26 may receive the extending section 54 in an insertion direction ID. According to a fabrication process in such a case, the arm 50 can be mounted to the insulator 20 while the insulator 20 is in a posture in which the receiving openings 26b of the insulator 20 are located so as to overlap the passing section 17 in an insertion direction ID.

In a sixth modification, instead of providing the F-point stopper 13 and the E-point stopper 14, an end section 16b or 16c of the guide section 16 may be used as a stopper limiting a rotatable angular range θ0 by being in contact with the extending section 54.

In a seventh modification, the rotation shaft 70 may be provided separately from the insertion section 52.

In an eighth modification, the variable resistor 60 functioning as a detection mechanism may adopt various other methods. For example, only one sliding contact point may be provided.

In a ninth modification, a detection mechanism may be configured to detect a magnetic field generated from a magnet held by a magnet holder as a rotating body using a hall IC held by a body as a fixed body.

In a tenth modification, the present disclosure may be applied to a liquid level detection device in a container equipped to a vehicle for other liquids, such as brake fluid, engine coolant, and engine oil. Further, containers are not limited to containers equipped to a vehicle and the present disclosure is also applicable to a liquid level detection device set in a liquid container equipped to various consumer devices and various transportation devices.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A liquid level detection device provided with a fixed body fixed to a container and a rotating body rotating with respect to the fixed body, and detecting a liquid level of a liquid contained in the container by means of a relative angle of the rotating body with respect to the fixed body, comprising:
a float floating in the liquid; and
an arm connecting the float and the rotating body and allowing the rotating body to rotate with up and down motions of the float, wherein:
the arm has an insertion section to be inserted into the rotating body and an extending section extending linearly and bent with respect to the insertion section,
the rotating body has an insertion hole in which the insertion section of the arm is inserted in an insertion direction and a holding section having a receiving opening which receives the extending section and holding the extending section received by the receiving opening,
the fixed body has a guide section covering the extending portion in a part of a region between a portion held by the holding section and a portion connected to the float within a rotatable angular range of the arm, and
the guide section is provided with a passing section used to dispose the part of the extending section inside the guide section.

2. The liquid level detection device according to claim 1, wherein
the guide section is formed to be allowed to undergo elastic deformation, and
a width of the passing section becomes narrower toward an inner side of the guide section and is smaller than a diameter of the extending section on an innermost side.

3. The liquid level detection device according to claim 1, wherein
the part of the extending section extends linearly from a point bent with respect to the insertion section, and
the passing section is provided along a radial direction of the insertion hole.

4. The liquid level detection device according to claim 1, wherein
the receiving opening receives the extending section in a circumferential direction of the insertion hole,
the fixed body has a stopper limiting the rotatable angular range by being in contact with the rotating body, and
let a position at which an edge of the extending section becomes in contact with the holding section of the rotating body when the rotating body is in contact with the stopper be a contact position, then the passing section is provided to a position at which the passing section overlaps the contact position in the insertion direction or a position opposite to the holding section with the contact position in between.

5. The liquid level detection device according to claim 4, wherein
the guide section has a clearance with the extending section held by the holding section at an end section.

6. The liquid level detection device according to claim 1, wherein
the guide section is provided integrally with the fixed body.
